(19) United States
(12) Patent Application Publication
(10) Pub. No.: US 2005/0079008 A1
(43) Pub. Date: Apr. 14, 2005

(54) Fitting with four-connectors for assembling BBQ grill trolley (cart)

(76) Inventor: Tse-Peng Lin, TaiPing City (TW)

Correspondence Address: LIN, TSE-PENG, No. 10, Alley 40, Lane 19, Sec. 3, Chung Shan Road, TaiPing City, Taichung Hsien, 411, TW

(21) Appl. No.: 10/684,195

(22) Filed: Oct. 14, 2003

(51) Int. Cl. F16B 1/00

(52) U.S. Cl. 403/217

(57) ABSTRACT

A die-casting Zn—Al alloy fitting with four connectors is invented to simplify the assembly of a stainless steel BBQ grill trolley. Four connectors of the fitting connect two rectangular tubes vertically and two rectangular tubes horizontally. Eight fittings are required to assemble a BBQ grill trolley. Two channels are formed on two larger side surfaces of each connector with a compressible plastic plate inserted to eliminate the clearance between the fitting and connected rectangular stainless steel tubes.

### BACKGROUND OF THE INVENTION

1. Field of Invention

This invention relates generally to a die-casting Zn—Al alloy fitting comprising four connectors, two vertical directions and two horizontal directions, and two channels with compressible plastic plate inserted on two larger surfaces of each connector that can be used to simplify the assembly of a stainless steel BBQ grill trolley. Eight fittings can connect rectangular stainless steel tubes to assemble a trolley of a BBQ grill.

2. Description of the Prior Art

Stainless steel BBQ grill trolley or cart is composed of legs, base, door, side panels, top panel and side shelves. In some cases it is assembled by welding and it will cause delivery cost increase due to its large volume especially if the grills are produced oversea. In other cases, it is assembled using brackets and bolts but consumer needs a little skill and lot of time and effort to assemble it. The present invention can greatly reduce the shipping cost and heavily reduce the consumer's effort to assemble a BBQ grill.

### SUMMARY OF THE PRESENT INVENTION

In accordance with the present invention, a die-casting Zn—Al alloy fitting with four connectors is applied to join the legs of a trolley. Each fitting can connect four rectangular stainless steel tubes in four different directions. Using four fittings can preassemble the lower base and upper stand of a trolley separately in production stage and consumers can easily assemble the trolley by connecting the legs together with it.

The fitting is made of Zn—Al alloy by die-casting therefore; its dimension can be very accurately controlled. There is a tolerance on inside dimension of rectangular stainless steel tubes due to production process allowance. Therefore the minimum inside dimension of the rectangular stainless steel is used as the criterion for fitting's dimension. There is a clearance between the fitting connector and the rectangular stainless steel tube in such situation. In order to eliminate the gap between the rectangular tube and fitting two channels on two larger side surfaces of each connector are formed with a thick compressible plastic plate inserted into each channel to ensure the tightness of connection.

### BRIEF DESCRIPTION OF THE DRAWINGS

FIG. 1 is a perspective view of a trolley of a BBQ grill with four-connectors fittings.

FIG. 2 is a perspective view of the four-connectors fitting.

FIG. 3 is a side view of the four-connectors fitting.

FIG. 4 is a front view of the four-connectors fitting.

FIG. 5 is a top view of the four-connectors fitting.

### DETAILED DESCRIPTION OF THE PREFERRED EMBODIMENTS

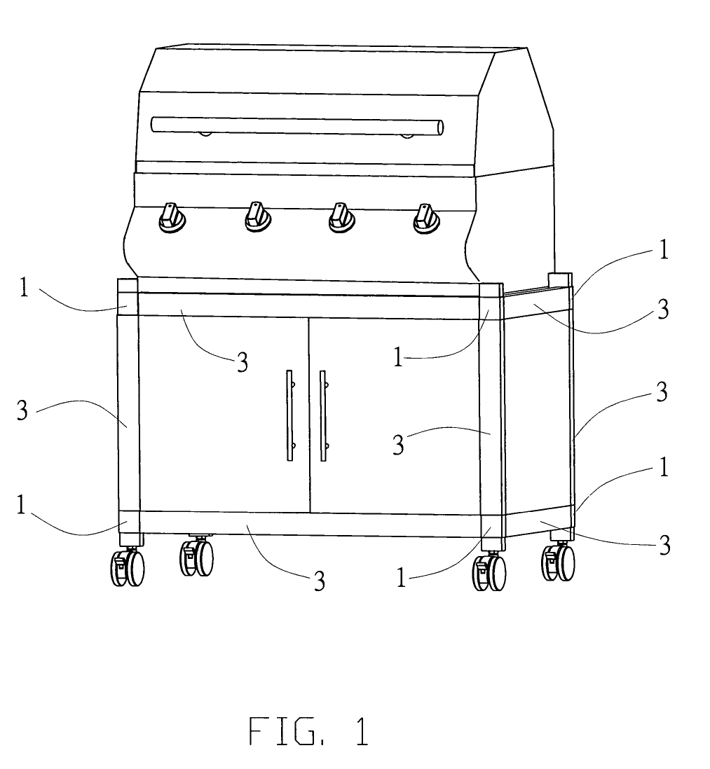

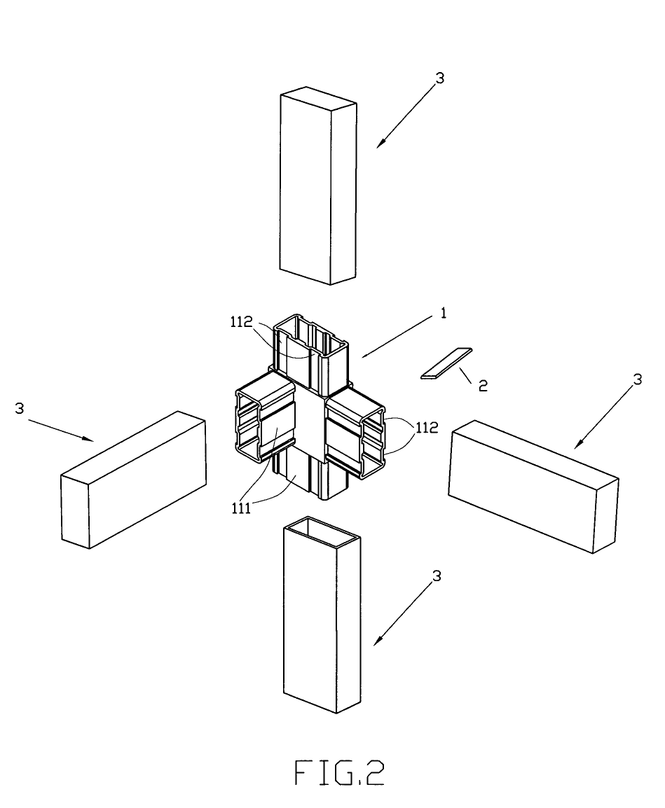

Referring to FIG. 1 and FIG. 2 rectangular stainless steel tubes 3, bottom base, and side panels in accordance with the present invention comprise a trolley of a BBQ grill. Eight fittings 1 are used to connect rectangular stainless steel tubes 3 to form the frame of a trolley and the side panels, bottom base, upper stand and doors can be assembled accordingly. The fitting 1 with four connection parts 11 said connectors is designed specially that only one type is required to assemble a trolley just turn the fitting 1 upside down and change its orientation for different corner connection.

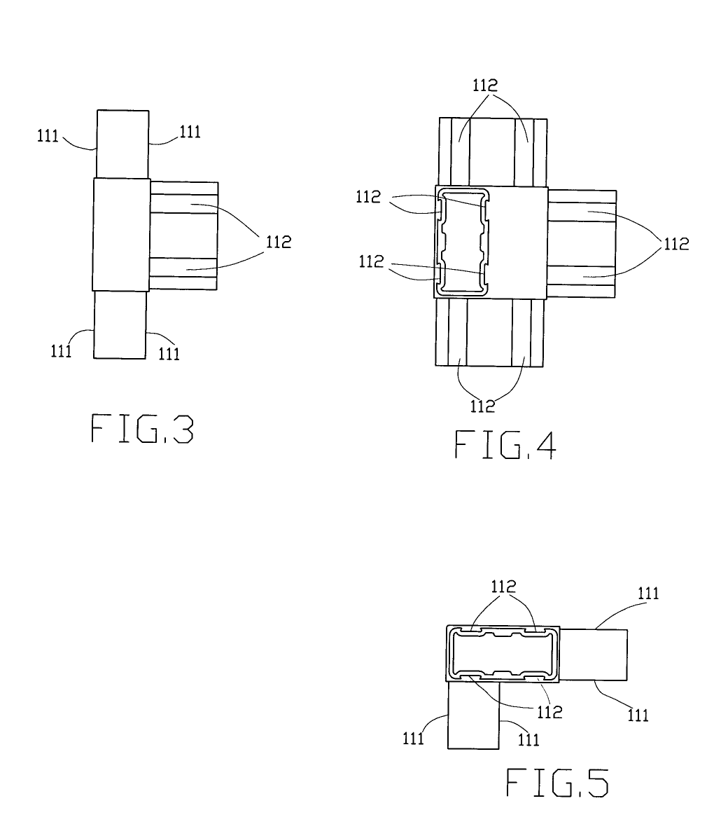

The fitting 1 is made of Zn—Al alloy by die-casting. Each fitting connects four rectangular stainless steel tubes 3 and eight fittings can be used to assemble a trolley of a BBQ grill see FIG. 1 and FIG. 2. Two square tubes 3 are connected vertically and two square tubes 3 are connected horizontally for each fitting. The shape of the fitting 1 is shown in FIG. 3 to FIG. 5 and its dimension can be different to suit different trolley size.

The inside dimension of rectangular stainless steel tubes 3 have tolerance during mass production therefore the minimum inside dimension of rectangular stainless steel tubes 3 is used as the outside dimension of the extruding connectors 11. Obviously, there is a clearance between rectangular stainless steel tubes 3 and fitting connector 11 when they are joined. In order to eliminate the clearance a special device is invented on the fitting. On two larger side surfaces 111 of extruding connector 11 two channels 112 with wider base and narrow opening are formed. A compressible plastic plate 2 is inserted into each channel 112. The thickness of the plastic plate 2 is larger than the clearance existed between the tubes 3 and the fitting connector 11. When the rectangular stainless steel tubes 3 connect to the fitting 1 it will compress the plastic plate 2 and tightly join with the fitting 1.

1. A fitting made of Zn—Al die-casting for BBQ grill trolley assembly comprising four connectors with two channels on two larger surfaces of each connector and compressible plastic plates are inserted into each channel.

2. The fitting as claimed in claim 1 wherein a compressible plastic plate insert into each channel to eliminate the clearance between fitting and rectangular stainless steel tubes.

3. The fitting as claimed in claim 1 wherein the shape of connectors can be rectangular, square and round to suit different tubes.
